(19) United States
(12) Patent Application Publication
(10) Pub. No.: US 2013/0050197 A1
(43) Pub. Date: Feb. 28, 2013

(54) STEREOSCOPIC IMAGE DISPLAY APPARATUS

(71) Applicant: Hajime Oosawa, Tokyo (JP)

(72) Inventor: Hajime Oosawa, Tokyo (JP)

(73) Assignee: KABUSHIKI KAISHA TOSHIBA, Tokyo (JP)

(21) Appl. No.: 13/406,244

(22) Filed: Feb. 27, 2012

(30) Foreign Application Priority Data
Aug. 31, 2011 (JP) 2011-189621

(51) Int. Cl. G06T 15/00

(52) U.S. Cl. 345/419

(57) ABSTRACT

A stereoscopic image display apparatus according to an embodiment includes: a display device including a display panel having a display screen formed of pixels arranged in a matrix form, and an optical plate which controls light rays emitted from pixels on the display panel; a memory which stores a test pattern having a plurality of multiple parallax images, a different multiple parallax image depending upon a viewing position being visible to a viewer, a multiple parallax image visible from an undesirable viewing position being marked with a symbol or message to urge the viewer to move to a better viewing position; and an image display control unit which exercises control to display the test pattern on the display panel.

### CROSS-REFERENCE TO RELATED APPLICATION

This application is based upon and claims the benefit of priority from prior Japanese Patent Application No. 2011-189621 filed on Aug. 31, 2011 in Japan, the entire contents of which are incorporated herein by reference.

### FIELD

Embodiments described herein relate generally to a stereoscopic image display apparatus.

### BACKGROUND

In the case of an autostereoscopic image display apparatus, a viewer (user) can view a stereoscopic image with naked eyes without using special glasses. In such a stereoscopic image display apparatus, a plurality of images which differ in viewpoint are displayed on a plane display device (for example, a liquid crystal display device) and light rays from these images are controlled by an optical plate such as a parallax barrier or a lenticular lens. As a result, the viewer views a stereoscopic image. In general, the optical plate is provided in front of the plane display device. The controlled light rays are led to both eyes of the viewer. If the viewing position of the viewer is adequate, the viewer can view a stereoscopic image. A zone of viewing positions where such a stereoscopic image can be visually recognized is referred to as viewing zone.

However, there is a problem that such a viewing zone is limitative. In other words, there is a pseudoscopy zone formed of viewing positions where, for example, a viewpoint of an image perceived by a left eye is located relatively on the right side as compared with a viewpoint of an image perceived by a right eye and consequently it becomes impossible to perceive a stereoscopic image correctly. In an autostereoscopic image display apparatus, therefore, a normal stereoscopic image cannot be viewed in some cases depending upon the viewing position of the viewer.

Therefore, it is conducted to provide a sensor on a stereoscopic image display apparatus to detect the position of the viewer, generate position information which indicates the position of the viewer, and only the viewing zone or the viewing zone and the pseudoscopy zone, and display the generated position information.

### BRIEF DESCRIPTION OF THE DRAWINGS

FIG. 1 is a diagram for explaining a stereoscopic image display apparatus according to an embodiment;

FIG. 2 is a diagram for explaining a stereoscopic image display apparatus according to an embodiment;

FIG. 3 is a block diagram for explaining a stereoscopic image display apparatus according to an embodiment;

FIG. 4 is a diagram showing display examples of a camera video and a viewing zone image;

FIGS. 5(a) to 5(i) are diagrams showing examples of a test pattern; and

FIG. 6 is a diagram for explaining a multiple parallax image.

### DETAILED DESCRIPTION

A stereoscopic image display apparatus according to an embodiment includes: a display device including a display panel having a display screen formed of pixels arranged in a matrix form, and an optical plate which controls light rays emitted from pixels on the display panel; a memory which stores a test pattern having a plurality of multiple parallax images, a different multiple parallax image depending upon a viewing position being visible to a viewer, a multiple parallax image visible from an undesirable viewing position being marked with a symbol or message to urge the viewer to move to a better viewing position; and an image display control unit which exercises control to display the test pattern on the display panel.

Hereafter, embodiments will be described with reference to the drawings.

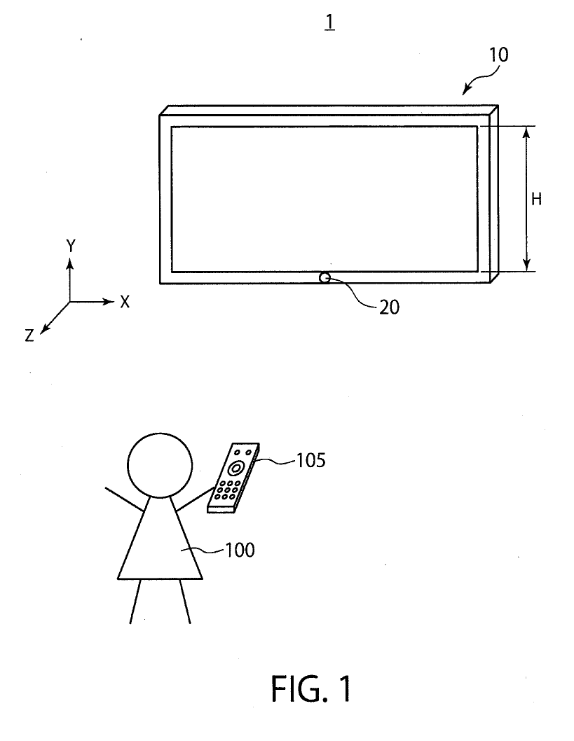

A stereoscopic image display apparatus according to an embodiment is shown in FIG. 1. The stereoscopic image display apparatus 1 in this embodiment is an autostereoscopic image display apparatus and includes a display device 10 which displays an image and a camera 20 which detects a position of a viewer on the basis of the image picked up. The display device 10 has a display screen formed of pixels arranged in a matrix form. The camera 20 is provided in a bottom frame included in a frame which surrounds the display screen of the display device 10.

In the stereoscopic image display apparatus according to the present embodiment, a coordinate system XYZ is set. For example, the coordinate system XYZ is set by taking a position of the camera 20 as origin, taking a plane parallel to the display screen of the display device 10 as an X-Y plane and taking a direction which is perpendicular to the X-Y plane and which approaches a viewer 100 as a positive direction of a Z axis. Incidentally, an X axis is set to be parallel to a lateral direction (horizontal direction) of the display screen, and a Y axis is set to be parallel to a longitudinal direction (vertical direction) of the display screen.

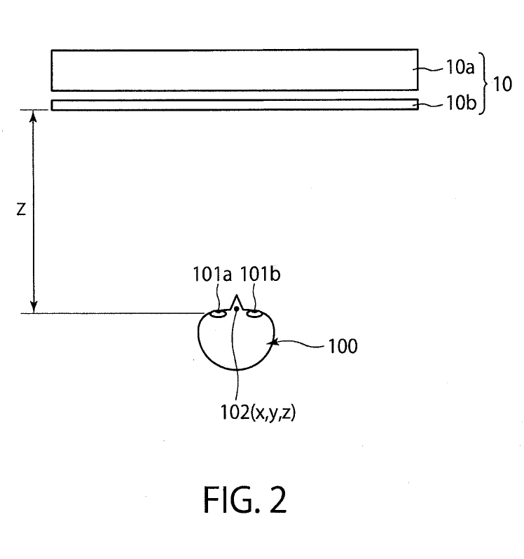

As shown in FIG. 2, the display device 10 includes a display panel 10a and an optical plate 10b provided in front of the display panel 10a. The optical plate 10b is, for example, a parallax barrier, a lenticular lens, or the like. The optical plate 10b controls light rays emitted from pixels in the display screen.

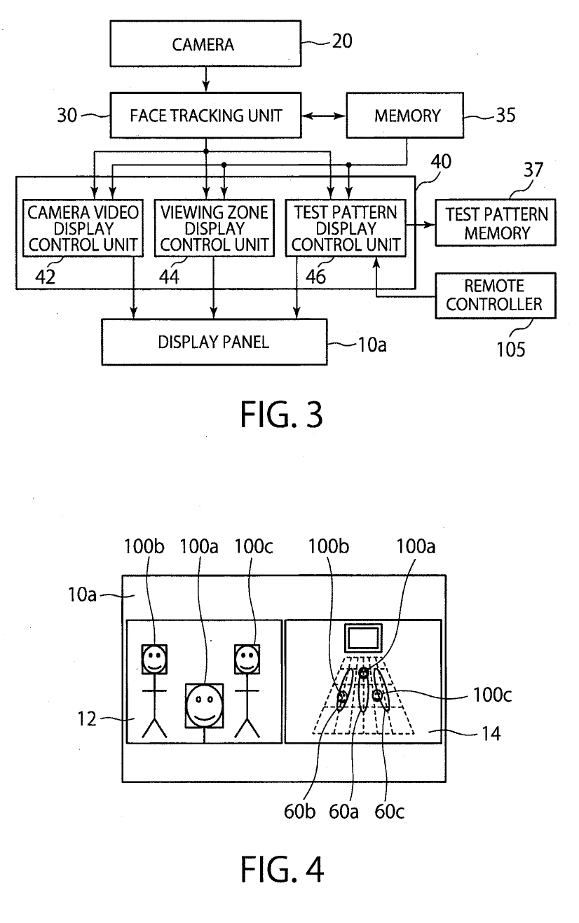

As shown in FIG. 3, the stereoscopic image display apparatus 1 according to the present embodiment includes a face tracking unit 30, a memory 35, a memory 37, and an image display control unit 40. The face tracking unit 30 conducts image processing on an image picked up by the camera 20, makes a determination whether a viewer exists in front of the display device 10. If the viewer 100 exists, the face tracking unit 30 detects a distance from the display device 10 to the viewer 100 and detects the position of the viewer 100 in the coordinate system. The face tracking unit 30 recognizes a face of the viewer 100 by conducting processing on an image supplied from the camera 20, and detects the distance from the display device 10 to the viewer 100 and the position of the viewer 100 in the coordinate system on the basis of the size of the face. For example, the camera 20 recognizes both eyes, that is, a left eye 101a and a right eye 101b of the viewer 100. Since the distance between centers of both eyes is nearly constant regardless of the person, the camera 20 can find a distance z to the viewer 100 on the basis of an image including the both eyes 101a and 101b. As shown in FIG. 2, the distance z means a distance from a front face of the optical plate 10b to a center 102 between eyes of the viewer 100. “The position of the viewer 100” means coordinates (x, y, z) of the center 102 between eyes of the viewer 100. The face tracking operation (detection operation) of the face tracking unit 30 is conducted with a constant repetition period (for example, intervals of one second to several seconds). In other words, the distance to the viewer 100 and the position of the viewer 100 are sampled with a constant repetition period.

The memory 35 successively stores the distance to the viewer 100 and the position of the viewer 100 sampled by the face tracking unit 30. The memory 37 stores a test pattern which will be described later.

Face tracking operation in the face tracking unit 30 is conducted when the viewer 100 selects an auto tracking mode via a remote controller 105 shown in FIG. 1 (auto tracking mode is on) and an image displayed on the display device 10 is a stereoscopic image. Furthermore, the face tracking operation in the face tracking unit 30 is conducted when the viewer 100 does not select the auto tracking mode via the remote controller 105 shown in FIG. 1 (auto tracking mode is off), an image displayed on the display device 10 is a stereoscopic image, and the viewer 100 selects the auto tracking mode manually via the remote controller 105. Furthermore, the face tracking operation in the face tracking unit 30 is also conducted when the auto tracking mode is off and an image displayed on the display device 10 has changed from a two-dimensional image to a stereoscopic image.

The image display control unit 40 includes a camera video display control unit 42, a viewing zone display control unit 44, and a test pattern display control unit 46.

The camera video display control unit 42 exercises control to display a camera video picked up by the camera 20 and sampled by the face tracking unit 30 on the display panel 10a. Incidentally, a camera video obtained when displayed on the display panel 10a is a mirror image, that is, a laterally inverted video. The viewing zone display control unit 44 exercises control to display a viewing zone image which indicates whether the viewer 100 is located in the viewing zone on the display panel 10a on the basis of the distance to the viewer 100 and the position of the viewer 100 obtained by sampling. This viewing zone image is displayed to represent a relative position relation between the viewer and the display screen of the display panel 10a. The camera video and the viewing zone image displayed on the display panel 10a are displayed by dividing one screen. FIG. 4 shows an example of a camera video 12 and a viewing zone image 14 displayed by dividing the display face of the display panel 10a. In this display example, there are three viewers 100a, 100b and 100c, and camera videos respectively of the viewers 100a, 100b and 100c are displayed as one camera video 12. In the viewing zone image 14, for example, three viewing zones 60a, 60b and 60c are displayed and it is displayed that the viewer 100a exists in the viewing zone 60a, the viewer 100b exists in the viewing zone 60b, and half of a face of the viewer 100c exists in the viewing zone 60c. The camera video 12 and the viewing zone image 14 are updated every face tracking operation conducted by the face tracking unit 30. If a viewer views the camera video 12 and the viewing zone image 14 and the viewer moves to locate the viewer within a viewing zone, therefore, the viewing zone image also changes in response to a change of a position of the viewer.

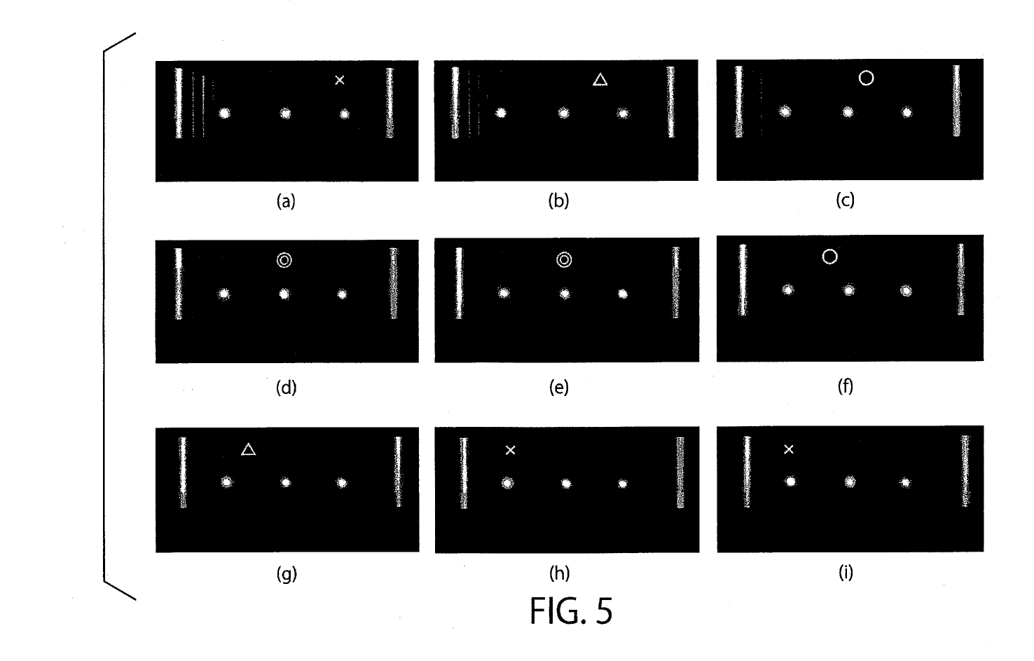

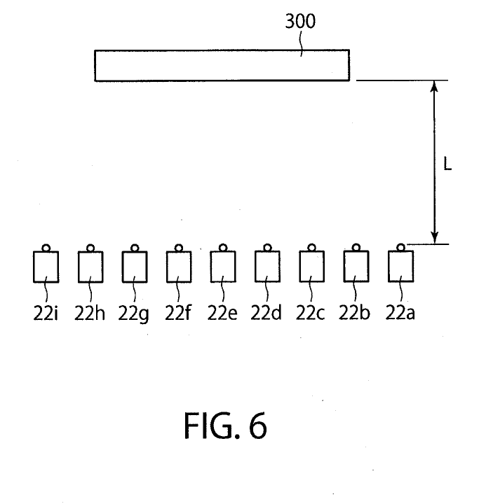

If a viewer depresses a button (for example, a blue button) on the remote controller 105 when the camera video 12 and the viewing zone image 14 are displayed, then a control signal is sent from the remote controller 105. Thereupon, a test pattern display control unit 46 starts operation and exercises control to display a test pattern stored in the test pattern memory 37 on the display panel 10a, on the basis of the control signal. An example of a test pattern in the case of a nine parallax scheme in which a stereoscopic image is displayed by using a nine parallax image out of a multi-parallax image is shown in FIGS. 5(a) to 5(i). The nine parallax image is formed by extracting parallax image components respectively of parallax images obtained by shooting the same object 300 with nine cameras 22a to 22i located at a constant distance (viewing distance) L from the object 300 as shown in FIG. 6 and combining them. FIG. 5(a) represents a nine parallax image which is visible when the viewer is located in the rightmost viewing zone. FIG. 5(b) represents a nine parallax image which is visible when the viewer is located in a viewing zone which is located on the immediate left side of the viewing zone in the case of FIG. 5(a). FIG. 5(c) represents a nine parallax image which is visible when the viewer is located in a viewing zone which is located on the immediate left side of the viewing zone in the case of FIG. 5(b). FIG. 5(d) represents a nine parallax image which is visible when the viewer is located in a viewing zone which is located on the immediate left side of the viewing zone in the case of FIG. 5(c). FIG. 5(e) represents a nine parallax image which is visible when the viewer is located in a viewing zone which is located on the immediate left side of the viewing zone in the case of FIG. 5(d). FIG. 5(f) represents a nine parallax image which is visible when the viewer is located in a viewing zone which is located on the immediate left side of the viewing zone in the case of FIG. 5(e). FIG. 5(g) represents a nine parallax image which is visible when the viewer is located in a viewing zone which is located on the immediate left side of the viewing zone in the case of FIG. 5(f). FIG. 5(h) represents a nine parallax image which is visible when the viewer is located in a viewing zone which is located on the immediate left side of the viewing zone in the case of FIG. 5(g). FIG. 5(i) represents a nine parallax image which is visible when the viewer is located in a viewing zone which is located on the immediate left side of the viewing zone in the case of FIG. 5(h). In other words, FIG. 5(i) represents a nine parallax image which is visible when the viewer is located in the leftmost viewing zone.

Depending upon the viewing zone in which the viewer is located, therefore, one of the nine parallax images shown in FIGS. 5(a) to 5(i) is visible. As shown in FIGS. 5(a) to 5(i), in the present embodiment, a nine parallax image which is visible from an optimum viewing position is marked with a double circle (FIGS. 5(d) and 5(e)), a nine parallax image visible from a viewing position which is not optimum but desirable is marked with a circle (FIGS. 5(c) and 5(f)), a nine parallax image which is visible from an undesirable viewing position is marked with a triangle (FIGS.

5(b) and 5(g)), and a nine parallax image which is a more undesirable viewing position is marked with a cross “x” (FIGS. 5(a), 5(h) and 5(i)). It is possible to urge the viewer to move to a more suitable viewing position by marking a nine parallax image with such a symbol.

Furthermore, a multiple parallax image which is visible from an undesirable viewing position may be marked with an arrow which indicates a moving direction toward a more desirable viewing position. For example, an arrow “→” indicates that a more desirable viewing position is located on the right side, whereas an arrow “←” indicates that a more desirable viewing position is located on the left side. It is possible to urge the viewer to move to a more suitable viewing position by marking a parallax image which is visible from an undesirable viewing position with an arrow in this way.

Furthermore, for example, a warning message “move to a suitable viewing position” may be displayed for a multiple parallax image which is visible from an undesirable viewing position. It is possible to urge the viewer to move to a more suitable viewing position by attaching a warning message to a multiple parallax image which is visible from an undesirable viewing position in this way.

Incidentally, although not illustrated, if an image signal sent from the external is a two-dimensional image signal, the image display control unit 40 has a function of generating depth information of an image from the two-dimensional image and generating a multiple parallax image signal from the two-dimensional image signal by using the depth information. If the image signal sent from the external is a multiple parallax image signal, the image display control unit 40 also has a function of changing it to a multiple parallax image signal suitable for the display panel 10a. In addition, the image display control unit 40 also has a function of converting these multiple parallax image signals to a stereoscopic image.

According to the present embodiment, it is possible to provide a stereoscopic image display apparatus capable of letting a viewer easily know whether the viewer is located in a more desirable viewing zone as described heretofore.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

1. A stereoscopic image display apparatus comprising:
a display comprising a display panel comprising a display screen comprising pixels arranged in a matrix and an optical plate configured to control light rays emitted from pixels on the display panel;
a memory configured to store a test pattern comprising a plurality of multiple parallax images on a same object and a symbol or message attached each of the plurality of multiple parallax images, the plurality of multiple parallax images being different observed depending upon a viewing position of a viewer, the symbol or message indicating whether the viewer is a better viewing position or not; and
an image display controller configured to display the test pattern on the display panel.

2. The stereoscopic image display apparatus according to claim 1, wherein the symbol or message comprises a symbol configured to indicate “x” or “Δ”.

3. The stereoscopic image display apparatus according to claim 1, wherein the symbol or message comprises an arrow configured to indicate a movement direction of the viewer.

4. The stereoscopic image display apparatus according to claim 1, wherein the symbol or message comprises a warning message.

5. The stereoscopic image display apparatus according to claim 1, further comprising:
a camera provided in the display; and
tracking unit configured to detect, based on an image picked up by the camera, a distance from the display to the viewer and a position of the viewer if a viewer exists in front of the display,
wherein the image display control unit further comprises a viewing zone image display control unit configured to exercise control to display a viewing zone image indicating whether the viewer is located in a viewing zone on the display panel based on the distance from the display to the viewer and the position of the viewer detected by the tracking unit.

6. The stereoscopic image display apparatus according to claim 5, wherein:
the tracking unit is configured to conduct tracking operation at intervals, and
the viewing zone image display control unit is configured to update the viewing zone image whenever the-face tracking operation is conducted.

7. The stereoscopic image display apparatus according to claim 5, wherein the image display control unit is configured to display the viewing zone image on the display panel and display the test pattern on the display panel based on a command given by the viewer.

8. The stereoscopic image display apparatus according to claim 5, wherein:
the image display control unit further comprises a camera video display control unit configured to exercise control to display a camera video picked up by the camera on the display panel, and
the image display control unit is configured to display the viewing zone image on the display panel and display the camera video picked up by the camera on the display panel.

9. The stereoscopic image display apparatus according to claim 1, wherein the symbol or message attached each of the plurality of multiple parallax images is shown in different position depending upon the plurality of multiple parallax images.
